(19) United States
(12) Patent Application Publication
(10) Pub. No.: US 2026/0119063 A1
(43) Pub. Date: Apr. 30, 2026

(54) USER FEEDBACK IN MEMORY TRAINING STARTUP SEQUENCES

(71) Applicant: Advanced Micro Devices, Inc., Santa Clara, CA (US)

(72) Inventors: MuZhen Xu, Shanghai (CN); KJ Kai-Chieh Chan, New Taipei City (TW); Ting Wang, Shanghai (CN); Lin Zheng, Shanghai (CN); KeFeng Tang, Shanghai (CN); KeWen Zhong, Shanghai (CN)

(73) Assignee: Advanced Micro Devices, Inc., Santa Clara, CA (US)

(21) Appl. No.: 18/929,725

(22) Filed: Oct. 29, 2024

(51) Int. Cl. G06F 3/06

(52) U.S. Cl. CPC G06F 3/0632; G06F 3/0604; G06F 3/0673

(57) ABSTRACT

User feedback in memory training startup sequences is described. In one or more implementations, a system includes a plurality of memory circuits configured as a system memory, and at least one processing circuit. The processing circuit executes platform initialization code configured to partially train a subset of memory circuits from a plurality of memory circuits during an initial stage of a startup sequence, and fully train each memory circuit of the plurality of memory circuits during a subsequent stage of the startup sequence. The processing circuit further executes basic input output system code configured to use the subset of memory circuits to output user feedback during the initial stage, and use the system memory to complete the startup sequence during the subsequent stage.

### BACKGROUND

To improve performance, computing systems increasingly rely on synchronous dynamic random-access memory (SDRAM), such as Double Data Rate (DDR) SDRAM. One inherent drawback of DDR SDRAM and other advanced memories is a longer memory training time. During startup sequences, memory training durations last over a minute or several minutes, depending on the type, quantity, and size of the memories being initialized. While memory training occurs, displays and other input/output devices that rely on system memory are inoperable.

### BRIEF DESCRIPTION OF THE DRAWINGS

FIG. 1 is a block diagram of a non-limiting example processing system configured to execute one or more applications for implementing user feedback in memory training startup sequences.

FIG. 2 is a block diagram of a non-limiting example system having first and second processing circuits communicatively coupled to a plurality of memory circuits and operable to implement user feedback in memory training startup sequences.

FIG. 3 is a timing diagram of a non-limiting example system that implements user feedback in memory training startup sequences.

FIG. 4 is a flow diagram illustrating an example process for implementing platform initialization aspects of user feedback in memory training startup sequences.

FIG. 5 is a flow diagram illustrating an example process for implementing basic input output system aspects of user feedback in memory training startup sequences.

### DETAILED DESCRIPTION

Modern computing systems realize performance gains from technological advancements in synchronous dynamic random-access memory (SDRAM), such as Double Data Rate (DDR) SDRAM. Each generation of DDR SDRAM improves speed, efficiency, and overall performance compared to previous generations. Double Data Rate 5 (DDR5) SDRAM significantly increases operational performance relative to Double Data Rate 4 (DDR4) and Double Data Rate 3 (DDR3) SDRAM. Despite the operational performance benefits of DDR5 and future generations of SDRAM, startup sequences (e.g., boot cycles at power up or reset) are slower with high-performance memories than previous generations of SDRAM due at least in part to considerably longer memory training times.

In the context of computer memory, “memory training” refers to a computing process that configures a memory controller to support memory operations using a system memory. An amount of time spent training and initializing the system memory is referred to as “memory training time” or simply “training time.” In one or more aspects, memory training occurs as part of a startup sequence performed during execution of basic input output system (BIOS) code. The BIOS code is executed to initialize a computing system when the computing system powers on, including to train the system memory.

Various parts of the computing system remain inoperable during startup until the BIOS code fully trains each memory circuit. A graphics processing unit (GPU) and display controller, for instance, use the system memory to control a display to output user feedback. In at least one implementation, a system memory has four memory circuits (e.g., four separate memory chips) with each memory circuit configured as a thirty-two gigabyte (GB) of DDR5 SDRAM. With a conventional training process, the four-circuit system memory has a memory training time of between eighty and two hundred seconds, depending on the specific DDR5 SDRAM technology and manufacturer. Training the four-circuit DDR5 memory system prevents the GPU and the display controller from illuminating the display to present user feedback for several minutes.

Prolonged memory training is a noticeable bottleneck during execution of the BIOS code. Delayed user feedback about system integrity diminishes a user experience. A user is left to wonder while the system memory is being trained whether the BIOS code is initializing the computing system correctly.

Conventional feedback systems use dedicated components, which operate independently of system memory, to provide reassurances during startup that a computing system is functioning correctly. Blinking lights, audible beepers, haptic vibrators, or other indicators are examples of dedicated components that convey user feedback during startup. A more expensive and complex solution is to include a baseboard management controller (BMC), which illuminates a display to provide visual feedback without using system memory. Using additional components to improve a user experience impacted by long memory training times increases complexity and cost.

In contrast to conventional feedback systems, user feedback in memory training startup sequences is described. Rather than adding extra components to implement a feedback system that operates independently from system memory, a modified startup sequence is executed to train a high-performance memory system (e.g., DDR5 SDRAM) in multiple stages.

In at least one example, a system, such as a desktop computer, includes a plurality of memory circuits and processing circuits. The memory circuits (e.g., DDR5 SDRAM circuits) are configured as a system memory. The system includes at least one processing circuit, for example, a single processing circuit, or a first and second processing circuit. In at least one example, the at least one processing circuit includes a first processing circuit, which in at least one implementation represents a platform security processor, and a second processing circuit, which represents a central processing unit.

The first processing circuit executes platform initialization code configured to partially train a subset of the memory circuits during an initial stage of a startup sequence. Memory training performed during the initial stage partially initializes the memory system to support limited functionality, such as for illuminating and controlling a display. For example, each memory circuit of the system memory is operable at a plurality of different memory speeds. During the initial stage, a subset of the memory system (e.g., a single memory circuit, fewer than each of the memory circuits in the memory system) is trained at the slowest memory speed, and is not trained at the other, faster memory speeds. The rest of the memory system (e.g., each other memory circuit) is left untrained during the initial stage. The slowest memory speed is used in one or more variations because training the slowest memory speed consumes less time to complete the training when compared to other faster memory speeds. By using less time to train the memory to perform a limited amount of functionality, the partial training occurs quickly (e.g., faster than completely training the memory system).

A user experience is improved during the initial stage. The second processing circuit executes BIOS code configured to use the subset of memory circuits to output user feedback during the initial stage. For example, during the execution of the BIOS code, the trained memory system subset is used at the slowest memory speed to illuminate and control a display to output user feedback about the startup sequence (e.g., text indicating the startup sequence started, a warning to not power down the computing system).

After outputting the user feedback, a subsequent stage of the startup sequence and the memory training occurs. The subsequent stage fully initializes the memory system to enable a smooth transition to a fully operational state. For example, the platform initialization code executed by the first processing circuit is configured to fully train each memory circuit of the system memory during the subsequent stage. In one or more aspects, during the subsequent stage, each memory circuit from the system memory is trained at each of the memory speeds. Then, the BIOS code executed during the second stage causes the second processing circuit to use the system memory to complete the startup sequence. The second processing circuit, for instance, completes the startup sequence by booting an operating system, which configures the system memory for program executions.

In at least one example implementation that has a four-circuit DDR5 memory system as described above, the first processing circuit finishes training a single memory circuit at the slowest memory speed in under thirty seconds to enable near-immediate output of user feedback about the startup sequence. The subsequent stage of memory training takes the first processing circuit approximately three minutes to train each of the four memory circuits across each of the memory speeds. However, with the user feedback output after the initial stage, user apprehension during the subsequent stage is reduced, without increasing hardware complexity or cost.

In some aspects, the techniques described herein relate to an apparatus including at least one processing circuit that executes: platform initialization code configured to partially train a subset of memory circuits from a plurality of memory circuits during an initial stage of a startup sequence, and fully train each of the plurality of memory circuits during a subsequent stage of the startup sequence, and basic input output system code configured to use the subset of memory circuits to display user feedback during the initial stage, and use each of the plurality of memory circuits to complete the startup sequence during the subsequent stage.

In some aspects, the techniques described herein relate to an apparatus, further including the plurality of memory circuits, wherein each of the plurality of memory circuits has at least two different operating speeds, and the platform initialization code is configured to partially train the subset of memory circuits during the initial stage using a slowest of the at least two different operating speeds.

In some aspects, the techniques described herein relate to an apparatus, wherein the platform initialization code is configured to fully train each of the plurality of memory circuits during the subsequent stage using each of the at least two different operating speeds.

In some aspects, the techniques described herein relate to an apparatus, wherein the platform initialization code is configured to check whether the startup sequence is in the initial stage or the subsequent stage based on a state of a flag maintained with settings of the basic input output system code.

In some aspects, the techniques described herein relate to an apparatus, wherein the basic input output system code is configured to change the state of the flag during the initial stage.

In some aspects, the techniques described herein relate to an apparatus, wherein the basic input output system code is configured to check whether the startup sequence is in the initial stage or the subsequent stage based on a training mode parameter reported from the platform initialization code.

In some aspects, the techniques described herein relate to an apparatus, wherein the platform initialization code is configured to set the training mode parameter based on whether the subset of memory circuits is partially trained or each of the plurality of memory circuits is fully trained.

In some aspects, the techniques described herein relate to a system including: a plurality of memory circuits configured as a system memory, and at least one processing circuit that executes: platform initialization code configured to partially train a subset of memory circuits from the system memory during an initial stage of a startup sequence, and fully train each memory circuit of the system memory during a subsequent stage of the startup sequence, and basic input output system code configured to use the subset of memory circuits to output user feedback during the initial stage, and use the system memory to complete the startup sequence during the subsequent stage.

In some aspects, the techniques described herein relate to a system, wherein the subset of memory circuits includes less than each of the plurality of memory circuits.

In some aspects, the techniques described herein relate to a system, wherein the subset of memory circuits includes a single memory circuit associated with a same channel of the system memory as a different memory circuit from the plurality of memory circuits.

In some aspects, the techniques described herein relate to a system, wherein the platform initialization code is configured to partially train the single memory circuit and refrain from partially training the different memory circuit during the initial stage.

In some aspects, the techniques described herein relate to a system, wherein the single memory circuit is partially trained at a slowest operating speed of the system memory.

In some aspects, the techniques described herein relate to a system, wherein each of the plurality of memory circuits has at least two different operating speeds, the platform initialization code is configured to: partially train the subset of memory circuits during the initial stage using a slowest of the at least two different operating speeds, and fully train each of the plurality of memory circuits during the subsequent stage using each of the at least two different operating speeds.

In some aspects, the techniques described herein relate to a system, further including a non-volatile memory that maintains a flag and settings of the basic input output system code, wherein the platform initialization code is configured to check whether the startup sequence is in the initial stage or the subsequent stage based on a state of the flag.

In some aspects, the techniques described herein relate to a system, wherein the basic input output system code is configured to change the state of the flag and reboot the system after the user feedback is output.

In some aspects, the techniques described herein relate to a system, wherein the at least one processing circuit includes a platform security processing circuit that executes the platform initialization code and a central processing circuit that executes the basic input output system code.

In some aspects, the techniques described herein relate to a system, further including a display controller that uses the subset of memory circuits during the initial stage to display the user feedback as text output on a display.

In some aspects, the techniques described herein relate to a method including: executing, by a computing device, platform initialization code to partially train a subset of memory circuits from a plurality of memory circuits during an initial stage of a startup sequence of the computing device, executing, by the computing device, basic input output system code to use the subset of memory circuits to display user feedback during the initial stage, executing, by the computing device, the platform initialization code to fully train each of the plurality of memory circuits during a subsequent stage of the startup sequence, and executing, by the computing device, the basic input output system code to use each of the plurality of memory circuits to complete the startup sequence during the subsequent stage.

In some aspects, the techniques described herein relate to a method, wherein: executing the platform initialization code to partially train the subset of memory circuits is in response to detecting a boot cycle of the computing device, and executing the platform initialization code to fully train each of the plurality of memory circuits is in response to detecting a subsequent boot cycle of the computing device.

In some aspects, the techniques described herein relate to a method, further including: executing, by the computing device, the basic input output system code to complete the startup sequence by booting an operating system of the computing device.

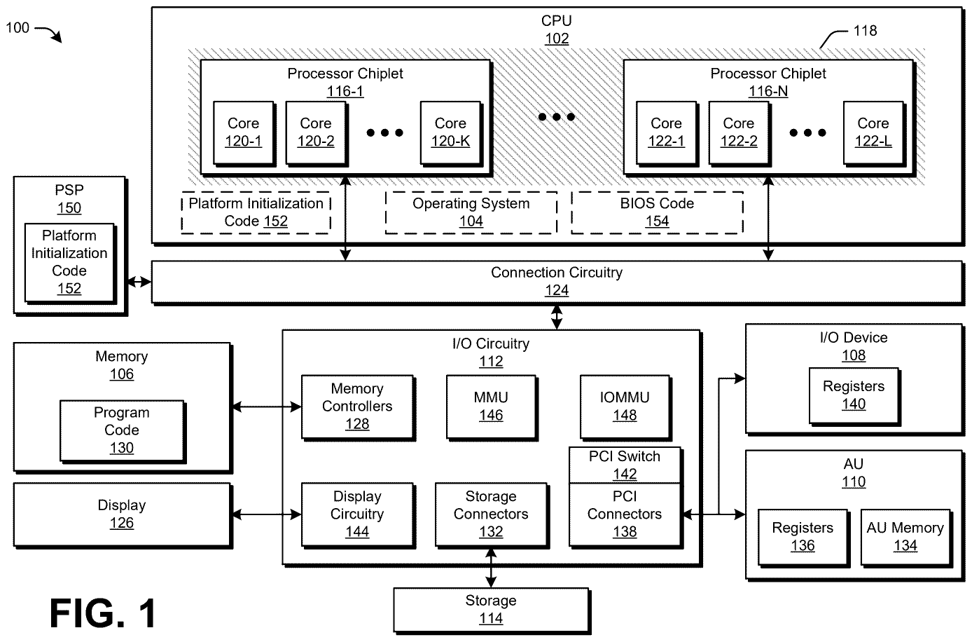

FIG. 1 is a block diagram of a processing system configured to execute one or more applications, in accordance with one or more implementations of user feedback in memory training startup sequences. FIG. 1 includes a processing system 100 configured to execute one or more applications, such as compute applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 100 includes a central processing unit (CPU) 102. In one or more implementations, the CPU 102 is configured to run an operating system (OS) 104 that manages the execution of applications. For example, the OS 104 is configured to schedule the execution of tasks (e.g., instructions) for applications, allocate portions of resources (e.g., memory 106, CPU 102, input/output (I/O) device 108, accelerator unit (AU) 110, storage 114) for the execution of tasks for the applications, provide an interface to I/O devices (e.g., I/O device 108) for the applications, or any combination thereof.

The CPU 102 includes one or more processor chiplets 116, which are communicatively coupled together by a data fabric 118 in one or more implementations.

Each of the processor chiplets 116, for example, includes one or more processor cores 120, 122 configured to concurrently execute one or more series of instructions, also referred to herein as “threads,” for an application. Further, the data fabric 118 communicatively couples each processor chiplet 116-N of the CPU 102 such that each processor core (e.g., processor cores 120) of a first processor chiplet (e.g., 116-1) is communicatively coupled to each processor core (e.g., processor cores 122) of one or more other processor chiplets 116. Though the example embodiment presented in FIG. 1 shows a first processor chiplet (116-1) having three processor cores (120-1, 120-2, 120-K) representing a K number of processor cores 122 and a second processor chiplet (116-N) having three processor cores (e.g., 122-1, 122-2, 122-L) representing an L number of processor cores 122, in other implementations (L being an integer number greater than or equal to one), each processor chiplet 116 may have any number of processor cores 120, 122. For example, each processor chiplet 116 can have the same number of processor cores 120, 122 as one or more other processor chiplets 116, a different number of processor cores 120, 122 as one or more other processor chiplets 116, or both.

Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

Additionally, within the processing system 100, the CPU 102 is communicatively coupled to an I/O circuitry 112 by a connection circuitry 124. For example, each processor chiplet 116 of the CPU 102 is communicatively coupled to the I/O circuitry 112 by the connection circuitry 124. The connection circuitry 124 includes, for example, one or more data fabrics, buses, buffers, queues, and the like. The I/O circuitry 112 is configured to facilitate communications between two or more components of the processing system 100 such as between the CPU 102, the memory 106, display 126, universal serial bus (USB) devices, peripheral component interconnect (PCI) devices (e.g., I/O device 108, AU 110), storage 114, and the like.

As an example, memory 106 includes any combination of one or more volatile memories and/or one or more non-volatile memories, examples of which include dynamic random-access memory (DRAM), static random-access memory (SRAM), non-volatile RAM, and the like. To manage access to the memory 106 by CPU 102, the I/O device 108, the AU 110, and/or any other components, the I/O circuitry 112 includes one or more memory controllers 128. These memory controllers 128, for example, include circuitry configured to manage and fulfill memory access requests issued from the CPU 102, the I/O device 108, the AU 110, or any combination thereof. Examples of such requests include read requests, write requests, fetch requests, pre-fetch requests, or any combination thereof. That is to say, these memory controllers 128 are configured to manage access to the data stored at one or more memory addresses within the memory 106, such as by CPU 102, the I/O device 108, and/or the AU 110.

When an application is to be executed by processing system 100, the OS 104 running on the CPU 102 is configured to load at least a portion of program code 130 (e.g., an executable file) associated with the application from, for example, a storage 114 into memory 106. This storage 114, for example, includes a non-volatile storage such as a flash memory, solid-state memory, hard disk, optical disc, or the like configured to store program code 130 for one or more applications.

To facilitate communication between the storage 114 and other components of processing system 100, the I/O circuitry 112 includes one or more storage connectors 132 (e.g., universal serial bus (USB) connectors, serial AT attachment (SATA) connectors, PCI Express (PCIe) connectors) configured to communicatively couple storage 114 to the I/O circuitry 112 such that I/O circuitry 112 is capable of routing signals to and from the storage 114 to one or more other components of the processing system 100.

In association with executing an application, in one or more scenarios, the CPU 102 is configured to issue one or more instructions (e.g., threads) to be executed for an application to the AU 110. The AU 110 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 110 includes one or more compute units that concurrently execute one or more threads of an application and store data resulting from the execution of these threads in AU memory 134. This AU memory 134, for example, includes any combination of one or more volatile memories and/or non-volatile memories, examples of which include caches, video RAM (VRAM), or the like. In one or more implementations, these compute units are also configured to execute these threads based on the data stored in one or more physical registers 136 of the AU 110.

To facilitate communication between the AU 110 and one or more other components of processing system 100, the I/O circuitry 112 includes or is otherwise connected to one or more connectors, such as PCI connectors 138 (e.g., PCIe connectors) each including circuitry configured to communicatively couple the AU 110 to the I/O circuitry such that the I/O circuitry 112 is capable of routing signals to and from the AU 110 to one or more other components of the processing system 100. Further, the PCIe connectors 138 are configured to communicatively couple the I/O device 108 to the I/O circuitry 112 such that the I/O circuitry 112 is capable of routing signals to and from the I/O device 108 to one or more other components of the processing system 100.

By way of example and not limitation, the I/O device 108 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 108 is configured to execute one or more operations, tasks, instructions, or any combination thereof based on one or more physical registers 140 of the I/O device 108. In one or more implementations, such physical registers 140 are configured to maintain data (e.g., operands, instructions, values, variables) indicating one or more operations, tasks, or instructions to be performed by the I/O device 108.

To manage communication between components of the processing system 100 (e.g., AU 110, I/O device 108) that are connected to PCI connectors 138, and one or more other components of the processing system 100, the I/O circuitry 112 includes PCI switch 142. The PCI switch 142, for example, includes circuitry configured to route packets to and from the components of the processing system 100 connected to the PCI connectors 138 as well as to the other components of the processing system 100. As an example, based on address data indicated in a packet received from a first component (e.g., CPU 102), the PCI switch 142 routes the packet to a corresponding component (e.g., AU 110) connected to the PCI connectors 138.

Based on the processing system 100 executing a graphics application, for instance, the CPU 102, the AU 110, or both are configured to execute one or more instructions (e.g., draw calls) such that a scene including one or more graphics objects is rendered. After rendering such a scene, the processing system 100 stores the scene in the storage 114, displays the scene on the display 126, or both. The display 126, for example, includes a cathode-ray tube (CRT) display, liquid crystal display (LCD), light emitting diode (LED) display, organic light emitting diode (OLED) display, or any combination thereof. To enable the processing system 100 to display a scene on the display 126, the I/O circuitry 112 includes display circuitry 144. The display circuitry 144, for example, includes high-definition multimedia interface (HDMI) connectors, DisplayPort connectors, digital visual interface (DVI) connectors, USB connectors, and the like, each including circuitry configured to communicatively couple the display 126 to the I/O circuitry 112. Additionally or alternatively, the display circuitry 144 includes circuitry configured to manage the display of one or more scenes on the display 126 such as display controllers, buffers, memory, or any combination thereof.

Further, the CPU 102, the AU 110, or both are configured to concurrently run one or more virtual machines (VMs), which are each configured to execute one or more corresponding applications. To manage communications between such VMs and the underlying resources of the processing system 100, such as any one or more components of processing system 100, including the CPU 102, the I/O device 108, the AU 110, and the memory 106, the I/O circuitry 112 includes memory management unit (MMU) 146 and input-output memory management unit (IOMMU) 148. The MMU 146 includes, for example, circuitry configured to manage memory requests, such as from the CPU 102 to the memory 106. For example, the MMU 146 is configured to handle memory requests issued from the CPU 102 and associated with a VM running on the CPU 102. These memory requests, for example, request access to read, write, fetch, or pre-fetch data residing at one or more virtual addresses (e.g., guest virtual addresses) each indicating one or more portions (e.g., physical memory addresses) of the memory 106. Based on receiving a memory request from the CPU 102, the MMU 146 is configured to translate the virtual address indicated in the memory request to a physical address in the memory 106 and to fulfill the request. The IOMMU 148 includes, for example, circuitry configured to manage memory requests (memory-mapped I/O (MMIO) requests) from the CPU 102 to the I/O device 108, the AU 110, or both, and to manage memory requests (direct memory access (DMA) requests) from the I/O device 108 or the AU 110 to the memory 106. For example, to access the registers 140 of the I/O device 108, the registers 136 of the AU 110, and/or the AU memory 134, the CPU 102 issues one or more MMIO requests. Such MMIO requests each request access to read, write, fetch, or pre-fetch data residing at one or more virtual addresses (e.g., guest virtual addresses) which each represent at least a portion of the registers 140 of the I/O device 108, the registers 136 of the AU 110, or the AU memory 134, respectively. As another example, to access the memory 106 without using the CPU 102, the I/O device 108, the AU 110, or both are configured to issue one or more DMA requests. Such DMA requests each request access to read, write, fetch, or pre-fetch data residing at one or more virtual addresses (e.g., device virtual addresses) which each represent at least a portion of the memory 106. Based on receiving an MMIO request or DMA request, the IOMMU 148 is configured to translate the virtual address indicated in the MMIO or DMA request to a physical address and fulfill the request.

Additionally, within the processing system 100, the CPU 102 is communicatively coupled to a platform security processor (PSP) 150 by the connection circuitry 124. The PSP 150 represents a dedicated security subsystem integrated within the processing system 100 to function independently from the CPU 102. In at least one implementation, the PSP 150 is implemented separately from the CPU 102. In another variation, the PSP 150 is included within the CPU 102 (e.g., to be closer to the processor chiplets 116 and the cores 120, 122). The PSP 150 implements a secure environment for sensitive operations performed in the processing system 100, manages a startup sequence (e.g., the boot process) to ensure secure startup, monitors the processing system 100 for suspicious activities, and operates independently of the CPU 102, the OS 104, and the program code 130 (e.g., to protect the PSP 150 from being compromised). For example, in managing the startup sequence, the PSP 150 executes platform initialization code 152 whenever the processing system 100 boots (e.g., powers on or is reset). The platform initialization code 152 implements part of the startup sequence of the processing system 100.

A basic input output system (BIOS) code 154 executes on the CPU 102 to implement the remainder of the startup sequence. The platform initialization code 152 and the BIOS code 154 are operatively coupled and functionally dependent. An interface is shared through the connection circuitry 124 to enable the platform initialization code 152 and the BIOS code 154 to jointly execute different parts of the startup sequence.

In this example, the platform initialization code 152 and the BIOS code 154 are depicted in the PSP 150 and the CPU 102, respectively, of the processing system 100. In variations, however, the platform initialization code 152 and the BIOS code 154 are included in and/or are implemented by one or more different components of the processing system 100, such as the CPU 102, the memory 106, the I/O device 108, the AU 110, the I/O circuitry 112, the storage 114, the PSP 150, and so forth. For example, as illustrated in dashed lines, the platform initialization code 152 is optionally implemented in the CPU 102 (e.g., a same processing circuit as the BIOS code 154). In at least one implementation, the platform initialization code 152 and the BIOS code 154 or portions of the platform initialization code 152 and the BIOS code 154 are included in at least two of the depicted components of the processing system 100. By way of example, the platform initialization code 152 may be included in or otherwise implemented by at least the PSP 150 and the BIOS code 154 may be included in or otherwise implemented by at least the CPU 102.

In variations, the processing system 100 can include any combination of the components depicted and described. For example, in at least one variation, the processing system 100 does not include one or more of the components depicted and described in relation to FIG. 1. Additionally or alternatively, in at least one variation, the processing system 100 includes additional and/or different components from those depicted. The 100 is configurable in a variety of ways with different combinations of components in accordance with the described techniques.

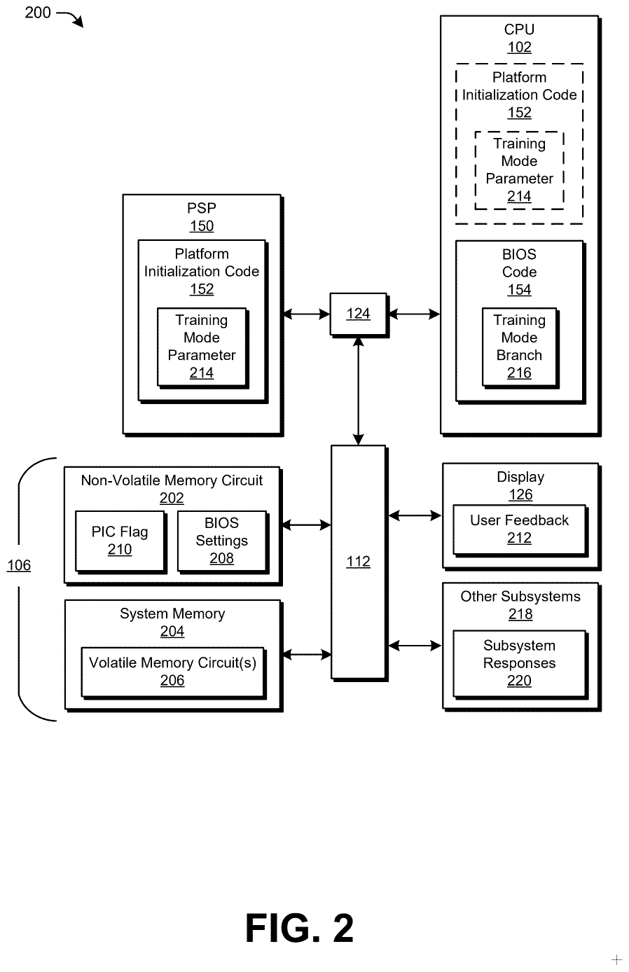

FIG. 2 is a block diagram of a non-limiting example system 200 having first and second processing circuits communicatively coupled to a plurality of memory circuits and operable to implement user feedback in memory training startup sequences. The system 200 is described in the context of the processing system 100, including with reference to similarly numbered figure elements, such as the PSP 150, the display 126, the connection circuitry 124, the I/O circuitry 112, the memory 106, and the CPU 102. Although illustrated as separate processing circuits, in variations of the system 200, the PSP 150 is implemented as part of the same processing circuit as the CPU 102. Likewise, the CPU 102 may be a graphics processing unit (GPU), an inference processing unit (IPU), the AU 110, or other processing component implemented separate from the PSP 150 or combined with the PSP 150 in a single processing circuit.

The memory 106 of the system 200 includes a non-volatile memory circuit 202 and a system memory 204. The non-volatile memory circuit 202 represents erasable and programmable read-only memory (EPROM), such as electrically erasable and programmable read-only memory (EEPROM), including but limited to examples of flash ROM. The non-volatile memory circuit 202 persistently stores the BIOS code 154, which is eventually loaded and executed by the CPU 102. The non-volatile memory circuit 202 is powered by a battery or other backup energy source, in at least one example, to preserve the content of the non-volatile memory circuit 202 for subsequent processing during a subsequent boot cycle (e.g., power-on cycle or reset) of the system 200. BIOS settings 208 and a PIC flag 210 are likewise maintained in the non-volatile memory circuit 202, for reasons that are apparent from the below description.

The system memory 204 is formed by a plurality of volatile memory circuits 206. Each of the memory circuits 206, for instance, is a DDR SDRAM type memory circuit. In at least one implementation, each of the memory circuits 206 is a same memory circuit. For example, the system memory 204 includes four of the memory circuits 206, with each of the memory circuits 206 configured as an individual thirty-two GB DDR5 SDRAM. In at least one implementation, the volatile memory circuits 206 include a single volatile memory circuit and in variations, the volatile memory circuits 206 include a plurality of same or different memory circuits that are configured as the system memory 204.

The PSP 150 and the CPU 102 are configured to implement a startup sequence that powers-on the system 200 and boots the OS 104 by executing the platform initialization code 152 and the BIOS code 154, respectively. The platform initialization code 152 focuses on specific hardware initialization and memory setup, while the BIOS code 154 handles broader hardware initialization and configuration tasks during the startup sequence to boot the system 200 to operate correctly. During an initial stage of the startup sequence, the platform initialization code 152 is executed by the PSP 150 to partially train a subset of the volatile memory circuits 206 from the system memory 204. Also during the initial stage of the startup sequence, the BIOS code 154 is executed by the CPU 102, which configures the CPU 102 to use the subset of the volatile memory circuits 206 to output user feedback 212.

For example, each of the volatile memory circuits 206 has at least two different operating speeds (e.g., a slow speed, a fast speed, a medium speed). Partially training a subset of the volatile memory circuits 206 in at least one aspect means to train at least one, and in some cases no more than one, of the volatile memory circuits 206 using one (e.g., a slowest) of the at least two different operating speeds. In at least one variation, the subset includes a single memory circuit from the plurality of volatile memory circuits 206, and that single memory circuit is a same channel of the system memory 204 as a different memory circuit of the plurality of volatile memory circuits 206. Partially training a subset of the volatile memory circuits 206 in at least one aspect means to train the single memory circuit (e.g., for a single speed) and refrain from partially training the different memory circuit. Training a single memory circuit for a single speed helps reduce a startup time associated with the startup sequence.

After the subset of the volatile memory circuits 206 is partially trained, the BIOS code 154 continues the initial stage of the startup sequence by causing the display circuitry 144 (e.g., a display controller) to control the display 126 to present user feedback. For example, execution of the BIOS code 154 causes a text based message to be stored in the partially trained subset of the system memory 204 as “System is booting, do not power off.” The I/O circuitry 112 and/or the display circuitry 144 retrieve the text based message from the partially trained subset of the system memory 204 to cause the display 126 to present the text based message as the user feedback 212. In at least one variation, a display controller included in the I/O circuitry 112, the display circuitry 144, or the display 126, accesses the partially trained subset of the volatile memory circuits 206 to display the user feedback 212. Presentation of the user feedback 212 improves user experience with the system 200, including to reduce apprehension about whether the system 200 is powering-on or not.

During a subsequent stage of the startup sequence, the platform initialization code 152 is executed by the PSP 150 to fully train each of the volatile memory circuits 206 of the system memory 204. For example, fully training each of the volatile memory circuits 206 in at least one aspect means to individually train each of the volatile memory circuits 206 at each different operating speed (e.g., at least two different operating speeds) that is supported by that individual memory circuit. Fully training the volatile memory circuits 206 in at least one aspect means to train each of the volatile memory circuits 206 using a slowest speed, a medium speed, a fastest speed, etc., until the system memory 204 is fully initialized to support multiple operating speeds. With the system memory 204 fully trained, the BIOS code 154 is executed during the subsequent stage of the startup sequence. The BIOS code 154 uses the system memory 204 to complete the startup sequence. For example, execution of the BIOS code 154 completes the startup sequence by booting the OS 104 to enable programs and applications to execute on the system 200 using the system memory 204.

As mentioned above, the BIOS settings 208 and the PIC flag 210 are maintained in the non-volatile memory circuit 202. The BIOS settings 208 are used during execution of the BIOS code 154 to perform operations associated with the startup sequence. One or more of the BIOS settings 208 are user modifiable, however, user modifications are not applied by the BIOS code 154 during the initial stage of the startup sequence. For example, changing the memory timing tCL (i.e., read latency) from one value to another does not affect operations of the BIOS code 154 to perform partial training. User modifications of the BIOS settings 208, however, are allowed to impact the full training processes that occur during the subsequent stage. This enables the BIOS code 154 to avoid potential risks of a partial training failure, or other unforeseen issues caused by user modifications to the BIOS settings 208.

The PIC flag 210 is used by the platform initialization code 152 to infer whether the startup sequence is in an initial stage or a subsequent stage. For example, the platform initialization code 152 executes on the PSP 150. As described above, the platform initialization code 152 either partially or fully trains the system memory 204, depending on whether the startup sequence is in the initial or subsequent stage. To check whether the startup sequence is in the initial stage or the subsequent stage, the platform initialization code 152 accesses the non-volatile memory circuit 202 to retrieve the PIC flag 210.

On boot (e.g., power up or reset) or at the beginning of the startup sequence, the state of the PIC flag 210 has a value to indicate the initial stage. When the state of the PIC flag 210 indicates the initial stage, the platform initialization code 152 partially trains the system memory 204. Then, when the BIOS code 154 finishes executing the initial stage of the startup sequence, the BIOS code 154 is configured to change the state of the flag to indicate the subsequent stage. In at least one implementation, the BIOS code 154 is configured to change the state of the PIC flag 210 to indicate the subsequent stage and reboot (e.g., cycle power or reset) the system 200 after the user feedback 212 is output.

On a subsequent boot cycle (e.g., a reset or after the initial stage), the state of the PIC flag 210 has a value to indicate the subsequent stage. When the state of the PIC flag 210 indicates the subsequent stage, the platform initialization code 152 fully trains the system memory 204. Then, the BIOS code 154 finishes executing the subsequent stage of the startup sequence by loading the OS 104 and completely booting up the system 200.

Although the PIC flag 210 is used by the platform initialization code 152 to infer whether the startup sequence is in an initial stage or a subsequent stage, the BIOS code 154 uses a training mode parameter 214 to check whether the startup sequence is in the initial or subsequent stage. For example, the platform initialization code 152 generates the training mode parameter 214 after training the system memory 204. During the initial stage, the training mode parameter 214 is set to a value that indicates the system memory 204 is partially trained, and during the subsequent stage, the training mode parameter 214 is set to a different value, which indicates the system memory is fully trained. The training mode parameter 214 is reported from the platform initialization code 152 to the BIOS code 154 or stored among the BIOS settings 208 that are accessible to the BIOS code 154.

A training mode branch 216 of the BIOS code 154 is conditioned on the training mode parameter 214 that is reported from the platform initialization code 152. For example, after partially training the system memory 204, the platform initialization code 152 sets the training mode parameter 214 to indicate that partial training occurred. The BIOS code 154 is executed by the CPU 102. When the CPU 102 executes the training mode branch 216, the CPU 102 evaluates the training mode parameter 214 to determine whether full or partial training occurred. Responsive to determining that the training mode parameter 214 indicates partial training occurred, the BIOS code 152 causes the CPU 102 to use the subset of the volatile memory circuits 206 to output user feedback 212.

After fully training the system memory 204, the platform initialization code 152 sets the training mode parameter 214 to indicate that full training occurred. The BIOS code 154 is executed by the CPU 102, and when the CPU 102 encounters the training mode branch 216 during the subsequent stage, the CPU 102 evaluates the training mode parameter 214 to determine that full training occurred. Responsive to determining that the training mode parameter 214 indicates full training occurred, the BIOS code 152 causes the CPU 102 to use each of the volatile memory circuits 206 to complete the startup sequence.

The system 200 includes other subsystems 218 that generate other subsystem responses 220. For example, the display 126 is described being used to output the user feedback 212 in text form. In other implementations, the other subsystems 218 perform functions or generate the subsystem responses 220, in response to executing the platform initialization code 152 and the BIOS code 154. As one example, the user feedback 212 is output as a vibration, a color-changing light, a beep, or other audible output to convey that the startup sequence is progressing (e.g., “System is booting, do not power down).

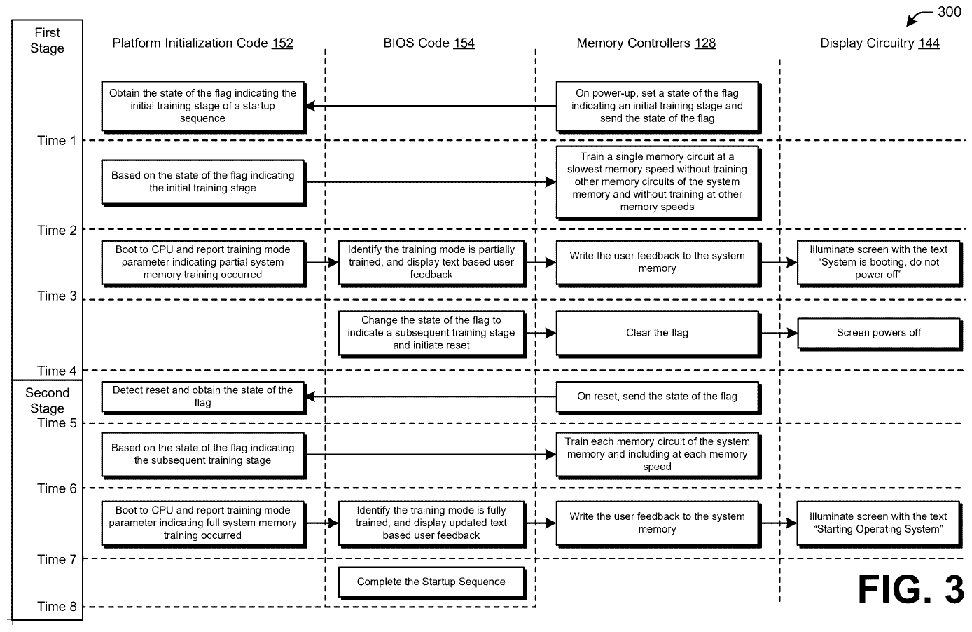

FIG. 3 is a timing diagram 300 of a non-limiting example system that implements user feedback in memory training startup sequences. For ease of description, the diagram 300 is described in the context of the systems 100 and 200. The timing diagram 300 includes four columns of actions taken by four different elements of the systems 100 and 200, during one of eight different times periods (e.g., time 1 through time 8) and one of two different stages (e.g., an initial stage and a subsequent stage) of a startup sequence. The first stage or initial stage of the startup sequence includes actions performed between times 1 through 4, and the second stage or subsequent stage of the startup sequence includes actions performed between time 5 and time 8.

At time 1, when the system 100 powers-up, the state of the PIC flag 210 is set to indicate an initial training stage and the memory controllers 128 send the state of the PIC flag 210 to the platform initialization code 152. The platform initialization code 152 obtains the state of the PIC flag 210 in response to one or more of the memory controllers 128 retrieving the state of the PIC flag 210 from the non-volatile memory circuit 202.

At time 2, based on the state of the PIC flag 210 indicating the initial training stage, the platform initialization code 152 interfaces with the memory controllers 128 to partially train a subset of the system memory 204. At least one of the memory controllers 128 partially trains a single memory circuit from the multiple volatile memory circuits 206 that form the system memory 204 to operate at a slowest memory speed. For example, the platform initialization code 152 interfaces with the memory controllers 128 to partially train subset of the system memory 204 during the initial stage using a slowest of at least two different operating speeds (e.g., slow instead of medium or fast). Temporarily reducing the operational speed of the single memory circuit accelerates the training process, while enabling partial memory functionality (e.g., at least part of the system memory 204 is operational at a slowest operating speed).

At time 3, the platform initialization code 152 boots the BIOS code 154 at the CPU 102. The platform initialization code 152 reports the training mode parameter 214 generated after partially training the single memory circuit from the multiple volatile memory circuits 206. The BIOS code 154 evaluates the training mode branch 216 based on the training mode parameter 214. In response to determining that the startup sequence is in the initial stage, the BIOS code 154 causes the memory controllers 128 and the display circuitry 144 to output the user feedback 212 about the startup sequence. For example, text to be displayed as the user feedback 212 is written by the memory controllers 128 in the single partially trained memory circuit from the multiple volatile memory circuits 206. The display circuitry 144 illuminates the display 126 with the text retrieved from the single partially trained memory circuit to present the text “System is booting, do not power off.”

At time 4, the BIOS code 154 changes the state of the PIC flag 210 maintained in the non-volatile memory circuit 202 to indicate the startup sequence is in a subsequent training stage. For example, the BIOS code 154 is configured to change the state of the PIC flag 210 and reboot (e.g., power cycle or reset) the system 100, 200 after the user feedback 212 is output. The memory controllers 128, for instance, clear the PIC flag 210 to indicate the startup sequence is in the subsequent training stage and not in the initial training stage. After clearing the PIC flag 210, the BIOS code 154 initiates a subsequent boot cycle (e.g., a reset) to trigger the platform initialization code 152 and the BIOS code 154 into the subsequent stage of the startup sequence. The detection of the subsequent boot cycle causes the display circuitry 144 to power off the display 126.

At time 5, in response to detection of the subsequent boot cycle initiated at time 4, the startup sequence progresses to the second stage (e.g., the subsequent stage). The platform initialization code 152 detects the detection of the subsequent boot cycle and obtains the state of the PIC flag 210 from the memory controllers 128. The memory controllers 128 retrieve the state of the PIC flag 210 from the non-volatile memory circuit 202.

At time 6, based on the state of the PIC flag 210 indicating the subsequent training stage, the platform initialization code 152 interfaces with the memory controllers 128 to fully train the system memory 204. For example, the platform initialization code 152 is configured to check whether the startup sequence is in the initial stage, or the subsequent stage based on a state of the PIC flag 210. When the state of the PIC flag 210 indicates the subsequent stage of the startup sequence, the platform initialization code 152 causes the memory controllers 128 to fully train each of the plurality of volatile memory circuits 206 using each of the at least two different operating speeds (e.g., slow, medium, and fast).

At time 7, the platform initialization code 152 boots the BIOS code 154 and reports the training mode parameter 214 to the BIOS code 154, which is executing at the CPU 102. The training mode parameter 214 causes the BIOS code 154 to resolve the training mode branch 216 to indicate that the startup sequence has entered the subsequent stage. The BIOS code 154 to uses the fully trained system memory 204 to complete the startup sequence. For example, the BIOS code 154 causes the memory controllers 128 to write updated text to the system memory 204 (e.g., “Starting Operating System”), and then use the display circuitry 144 to illuminate the display 126 and present the updated text.

At time 8, the BIOS code 154 completes the startup sequence. For example, the BIOS code 154 loads the OS 104 from the storage 114 to the system memory 204. The BIOS code 154 boots the OS 104 from the system memory 204 to initialize other aspects of the system 100, 200, and prepare the system 100, 200 for executing applications and the program code 130.

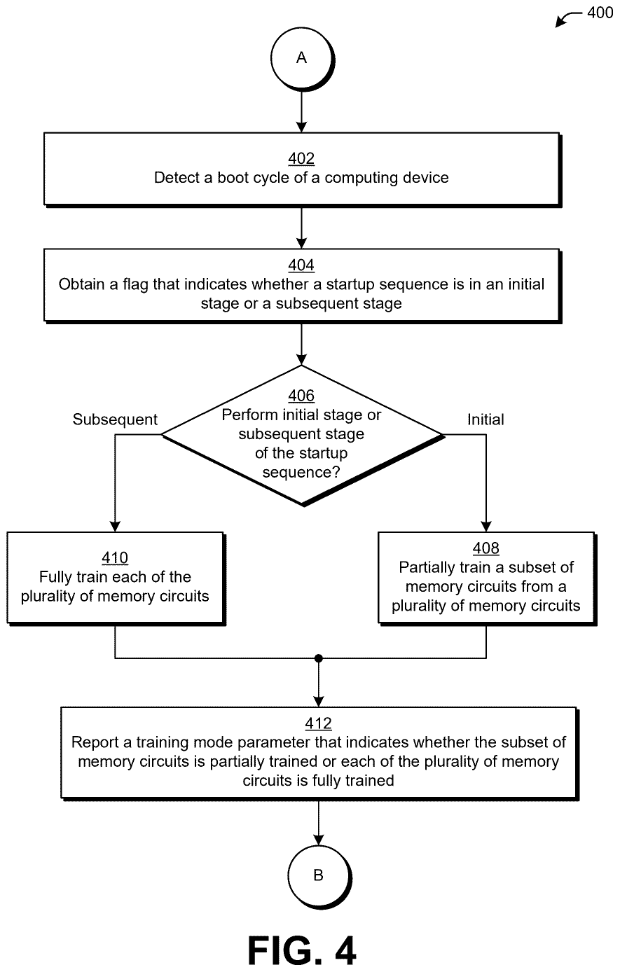

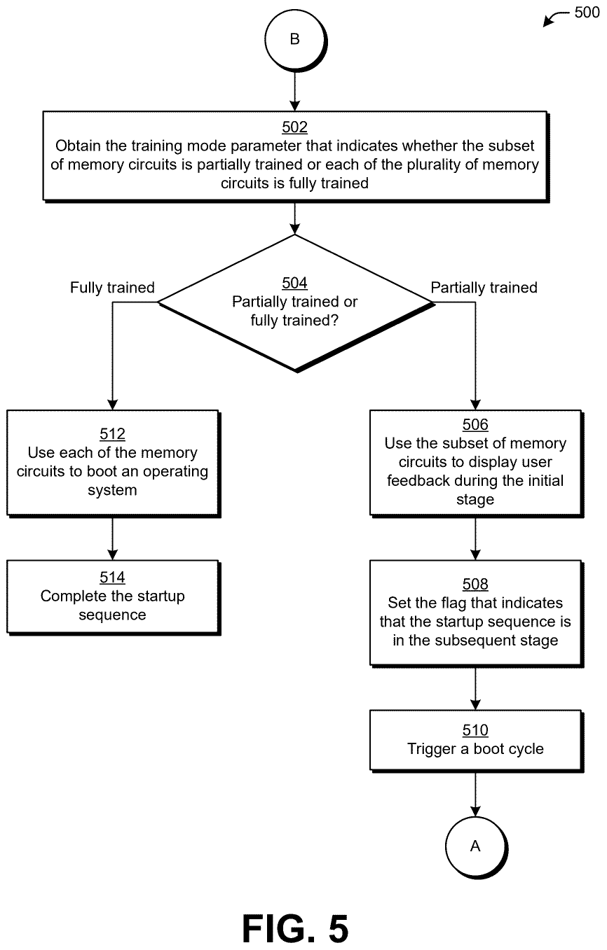

FIG. 4 is a flow diagram illustrating an example process 400 for implementing platform initialization aspects of user feedback in memory training startup sequences. FIG. 5 is a flow diagram illustrating an example process 500 for implementing basic input output system aspects of user feedback in memory training startup sequences. The processes 400 and 500 are described together in the context of a single implementation.

The process 400 starts at block 402, with detecting a boot cycle (e.g., power-on cycle or a reset) of a computing device. For example, the platform initialization code 152 is executed by the PSP 150 of the system 100.

A flag that indicates whether a startup sequence is in an initial stage, or a subsequent stage is obtained at block 404. For example, the platform initialization code 152 reads the state of the PIC flag 210 to check whether to execute the initial or subsequent stage of the startup sequence.

At block 406, the flag is checked to determine whether to perform the initial stage or the subsequent stage of the startup sequence. For example, when the flag is set to a particular value, the platform initialization code 152 follows an execution path at block 408 to perform the initial stage of the startup sequence and when the flag is set to a different value, the platform initialization code 152 follows an execution path at block 410 to perform the subsequent stage of the startup sequence.

At block 408, the platform initialization code 152 executes on the PSP 150 to partially train a subset of memory circuits from a plurality of memory circuits. For example, one of the volatile memory circuits 206 of the system memory 204 are trained, at a single operating speed, to allow a form of user feedback (e.g., the user feedback 212) to be output and provide assurance that the startup sequence is progressing.

At block 410, the platform initialization code 152 executes on the PSP 150 to fully train each of the memory circuits from the plurality of memory circuits. For example, each of the volatile memory circuits 206 of the system memory 204 is trained, at each operating speed, to enable full functionality with the system memory 204 and complete the startup sequence.

At block 412, the platform initialization code 152 reports a training mode parameter 214 that indicates whether the subset of memory circuits is partially trained or each of the plurality of memory circuits is fully trained. For example, when the program initialization code 152 finishes the initial stage of the startup sequence, the BIOS code 154 is triggered on the CPU 102 and the training mode parameter 214 is sent from the PSP 150 and/or the program initialization code 152 to the CPU 102 and/or the BIOS code 154.

Following execution of the block 412, the process 500 begins at block 502. At block 502, the BIOS code 154 obtains the training mode parameter 214 that indicates whether the subset of memory circuits is partially trained or each of the plurality of memory circuits is fully trained.

At block 504, the training mode parameter 214 is checked to determine whether to perform the initial stage or the subsequent stage of the startup sequence. For example, when the training mode parameter 214 is set to a particular value, the BIOS code 154 follows an execution path at block 506 to perform the initial stage of the startup sequence and when the training mode parameter 214 is set to a different value, the BIOS code 154 follows an execution path at block 512 to perform the subsequent stage of the startup sequence.

When the execution path proceeds to block 506, the BIOS code 154 is executed to use the subset of memory circuits to display user feedback during the initial stage. For example, the BIOS code 154 stores an instruction, command, or message in the volatile memory circuit 206 that is partially trained by the platform initialization code 152. The display circuitry 144 reads the instruction, command, or message from the volatile memory circuit 206 and drives the display 126 to present the user feedback 212.

At block 508, the process 500 continues with setting the flag that indicates that the startup sequence is in the subsequent stage. For example, the BIOS code 154 changes the state of the PIC flag 210 to indicate that the startup sequence is transitioning into the subsequent stage.

At block 510, the process 500 triggers a subsequent boot cycle (e.g., a next power cycle or a reset) of the system 100, 200 to end the initial stage of the startup sequence. For example, the BIOS code 154 resets the system 100, 200, which causes the process 400 to start again by detecting the subsequent boot cycle (e.g., the next boot cycle).

When the execution path proceeds to block 512, the BIOS code 154 is executed to use each of the memory circuits to boot an operating system. For example, the BIOS code 154 loads the OS 104 from the storage 114 and into the system memory 204 to boot up the system 100, 200 with access and utilization of each of the volatile memory circuits 206.

At block 514, the process 500 ends by completing (e.g., finishing) the startup sequence. For example, the BIOS code 154 boots the OS 104, and finishes initializing the rest of the system 100, 200 to be operational for executing applications, and the program code 130.

In summary, with an initial pass through the process 400, the program initialization code 152 implements blocks 402, 404, 406, 408, and 412. Following the initial pass through the process 400, the BIOS code 154 executes an initial pass through the process 500. The BIOS code 154 implements blocks 502, 504, 506, 508, and 510 during the initial pass. After the initial passes through the processes 400 and 500, subsequent passes through the processes 400 and 500 occur. For example, during a subsequent pass through the processes 400 and 500, the program initialization code 152 implements blocks 402, 404, 406, 410, and 412 and BIOS code 154 executes the blocks 502, 504, 512, and 514.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (e.g., the platform initialization code 152, the BIOS code 154) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a CPU, a Digital Signal Processor (DSP), a GPU, a parallel accelerated processor, a plurality of microprocessors, one or more microprocessors in association with a DSP core, a controller, a microcontroller, an Application Specific Integrated Circuit (ASIC), a Field Programmable Gate Array (FPGA) circuit, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read-only memory (ROM), a random-access memory (RAM), a register, cache memory, semiconductor memory devices, magnetic media such as internal hard disks and removable disks, magneto-optical media, and optical media such as a CD-ROM disk, or a digital versatile disk (DVD).

What is claimed is:

1. An apparatus comprising at least one processing circuit that executes:
platform initialization code configured to partially train a subset of memory circuits from a plurality of memory circuits during an initial stage of a startup sequence, and fully train each of the plurality of memory circuits during a subsequent stage of the startup sequence; and
basic input output system code configured to use the subset of memory circuits to display user feedback during the initial stage, and use each of the plurality of memory circuits to complete the startup sequence during the subsequent stage.

2. The apparatus of claim 1, further comprising the plurality of memory circuits, wherein each of the plurality of memory circuits has at least two different operating speeds, and the platform initialization code is configured to partially train the subset of memory circuits during the initial stage using a slowest of the at least two different operating speeds.

3. The apparatus of claim 2, wherein the platform initialization code is configured to fully train each of the plurality of memory circuits during the subsequent stage using each of the at least two different operating speeds.

4. The apparatus of claim 1, wherein the platform initialization code is configured to check whether the startup sequence is in the initial stage or the subsequent stage based on a state of a flag maintained with settings of the basic input output system code.

5. The apparatus of claim 4, wherein the basic input output system code is configured to change the state of the flag during the initial stage.

6. The apparatus of claim 1, wherein the basic input output system code is configured to check whether the startup sequence is in the initial stage or the subsequent stage based on a training mode parameter reported from the platform initialization code.

7. The apparatus of claim 6, wherein the platform initialization code is configured to set the training mode parameter based on whether the subset of memory circuits is partially trained or each of the plurality of memory circuits is fully trained.

8. A system comprising:
a plurality of memory circuits configured as a system memory; and
at least one processing circuit that executes:
platform initialization code configured to partially train a subset of memory circuits from the system memory during an initial stage of a startup sequence, and fully train each memory circuit of the system memory during a subsequent stage of the startup sequence; and
basic input output system code configured to use the subset of memory circuits to output user feedback during the initial stage, and use the system memory to complete the startup sequence during the subsequent stage.

9. The system of claim 8, wherein the subset of memory circuits includes less than each of the plurality of memory circuits.

10. The system of claim 8, wherein the subset of memory circuits includes a single memory circuit associated with a same channel of the system memory as a different memory circuit from the plurality of memory circuits.

11. The system of claim 10, wherein the platform initialization code is configured to partially train the single memory circuit and refrain from partially training the different memory circuit during the initial stage.

12. The system of claim 10, wherein the single memory circuit is partially trained at a slowest operating speed of the system memory.

13. The system of claim 8, wherein each of the plurality of memory circuits has at least two different operating speeds, the platform initialization code is configured to:
partially train the subset of memory circuits during the initial stage using a slowest of the at least two different operating speeds; and
fully train each of the plurality of memory circuits during the subsequent stage using each of the at least two different operating speeds.

14. The system of claim 8, further comprising a non-volatile memory that maintains a flag and settings of the basic input output system code, wherein the platform initialization code is configured to check whether the startup sequence is in the initial stage or the subsequent stage based on a state of the flag.

15. The system of claim 14, wherein the basic input output system code is configured to change the state of the flag and reboot the system after the user feedback is output.

16. The system of claim 8, wherein the at least one processing circuit comprises a platform security processing circuit that executes the platform initialization code and a central processing circuit that executes the basic input output system code.

17. The system of claim 8, further comprising a display controller that uses the subset of memory circuits during the initial stage to display the user feedback as text output on a display.

18. A method comprising:
executing, by a computing device, platform initialization code to partially train a subset of memory circuits from a plurality of memory circuits during an initial stage of a startup sequence of the computing device;
executing, by the computing device, basic input output system code to use the subset of memory circuits to display user feedback during the initial stage;
executing, by the computing device, the platform initialization code to fully train each of the plurality of memory circuits during a subsequent stage of the startup sequence; and
executing, by the computing device, the basic input output system code to use each of the plurality of memory circuits to complete the startup sequence during the subsequent stage.

19. The method of claim 18, wherein:
executing the platform initialization code to partially train the subset of memory circuits is in response to detecting a boot cycle of the computing device; and
executing the platform initialization code to fully train each of the plurality of memory circuits is in response to detecting a subsequent boot cycle of the computing device.

20. The method of claim 18, further comprising:
executing, by the computing device, the basic input output system code to complete the startup sequence by booting an operating system of the computing device.
